(19) United States
(12) Patent Application Publication
(10) Pub. No.: US 2007/0267273 A1
(43) Pub. Date: Nov. 22, 2007

(54) Foldable conveyor with automatic tensioning device

(76) Inventors: Joseph M. Walsh, Grafton, WI (US); Gary E. Webers, Sheboygan, WI (US)

Correspondence Address: QUARLES & BRADY LLP, 411 E. WISCONSIN AVENUE, SUITE 2040, MILWAUKEE, WI, 53202-4497, US

(21) Appl. No.: 11/751,945

(22) Filed: May 22, 2007

Related U.S. Application Data
(60) Provisional application No. 60/802,363, filed on May 22, 2006.

(51) Int. Cl. B65G 21/10

(52) U.S. Cl. 198/632

(57) ABSTRACT

A foldable conveyor includes a conveyor frame having a horizontal section and an inclined section pivotable with respect to the horizontal section to permit the conveyor to be in a compact folded state as well as an unfolded operational state. The conveyor includes a continuous belt such as a hinged metal belt which is movable to transport material from a loading area to a discharge area. A tensioning device provides appropriate tension on the belt to prevent the belt from interfering in an unfolding operation.

### CROSS-REFERENCE TO RELATED APPLICATIONS

This application claims priority to U.S. provisional patent application Ser. No. 60/802363, filed May 22, 2006, and titled “Foldable Conveyor System”.

### STATEMENT REGARDING FEDERALLY SPONSORED RESEARCH OR DEVELOPMENT

Not applicable.

### FIELD OF THE INVENTION

The present invention relates generally to a foldable conveyor, and in particular to a foldable conveyor having an automatic tensioning device which permits the conveyor to be shipped with an installed belt and unfolded without difficulty.

### BACKGROUND OF THE INVENTION

Flexible metal belt conveyors are used for many purposes in manufacturing and industrial fields for moving machine parts being treated or processed, moving metal “chips” generated in machining processes, or moving raw materials such as sand, gravel, ores or the like. One type of known metal belt conveyor includes a lower horizontal loading section, an inclined section, and optionally an elevated horizontal section. Such a conveyor is operable to move material from a loading area to a discharge area. The metal belts typically take the form of plates or aprons which include an elongated flat body with staggered hinge barrels formed along their front and rear edges. The hinge barrels of one apron are interdigited with the hinge barrels of another apron to form a piano-type hinge with a long rod passing through the barrels. Rollers are typically mounted on the projecting ends of the rods outboard of the aprons. Upstanding side wings are usually mounted on the rods between the lateral edges of the aprons and the rollers. The side wings typically link successive rods and overlap each other to form a series of wings. The upstanding side wings function to retain material on the upper conveying surface of the belt. An example of this form of metal belt conveyor is described in U.S. Pat. No. 3,233,722 and U.S. Pat. No. 4,473,151.

The overall length of such a conveyor makes it bulky to ship such that it is desirable to provide a hinge mechanism between the horizontal loading section and the inclined section to allow the conveyor to be folded for shipping and unfolded for operation once at a desired destination. A folded conveyor is more compact and thus cheaper to ship. Such a foldable conveyor is described for example in U.S. Pat. No. 6,626,285. However, the hinge mechanism described therein is complex making it more difficult to manufacture and more difficult to assemble the conveyor for operation.

### BRIEF SUMMARY OF THE INVENTION

It is desirable to provide a foldable conveyor which in a folded state is more compact than its unfolded state and thus cheaper to ship. Such a foldable conveyor should be easy to unfold and easy to set up at its destination. A foldable conveyor having a simple pivot hinge meets these requirements. Shipping such a foldable conveyor with an installed belt also reduces set up time. However, a foldable conveyor having a simple pivot hinge will have a partial gap between the horizontal loading section and the inclined section in the folded state, such that without an automatic tensioning device, as the conveyor is unfolded, the belt lacks appropriate tension and can bunch up in the area of the gap and interfere with the unfolding operation. Thus one object of the present invention is to provide a foldable conveyor which can be shipped with an installed belt and which includes a tensioning device which operates to automatically tension the belt and prevent the belt from interfering with an unfolding operation. Such a foldable conveyor can be shipped with the belt installed and is easily unfolded and assembled at its destination.

These and other objects, advantages, and aspects of the invention will become apparent from the following description. In the description, reference is made to the accompanying drawings which form a part hereof, and in which there is shown a preferred embodiment of the invention. Such embodiment does not necessarily represent the full scope of the invention.

### BRIEF DESCRIPTION OF THE DRAWINGS

FIG. 1 is a side elevational view of a foldable conveyor in a folded state and including an automatic tensioning device;

FIG. 2 is a side elevational view of the conveyor of FIG. 1 in an unfolded state with the tensioning device removed;

FIG. 3 is a detailed view of the joint between the sections of the conveyor of FIG. 1;

FIG. 4 is a cross-sectional view taken along the line 4-4 of FIG. 2;

FIG. 5 is cross-sectional view taken along the line 5-5 of FIG. 2;

FIG. 6 is a simplified top view of the tensioning device attached to the conveyor frame;

FIG. 7 is a simplified side view of the tensioning device attached to the conveyor frame;

FIG. 8 is an end view of the conveyor showing the bearing assemblies; and

FIG. 9 is a side view of the bearing assembly showing the holding mechanism.

### DETAILED DESCRIPTION

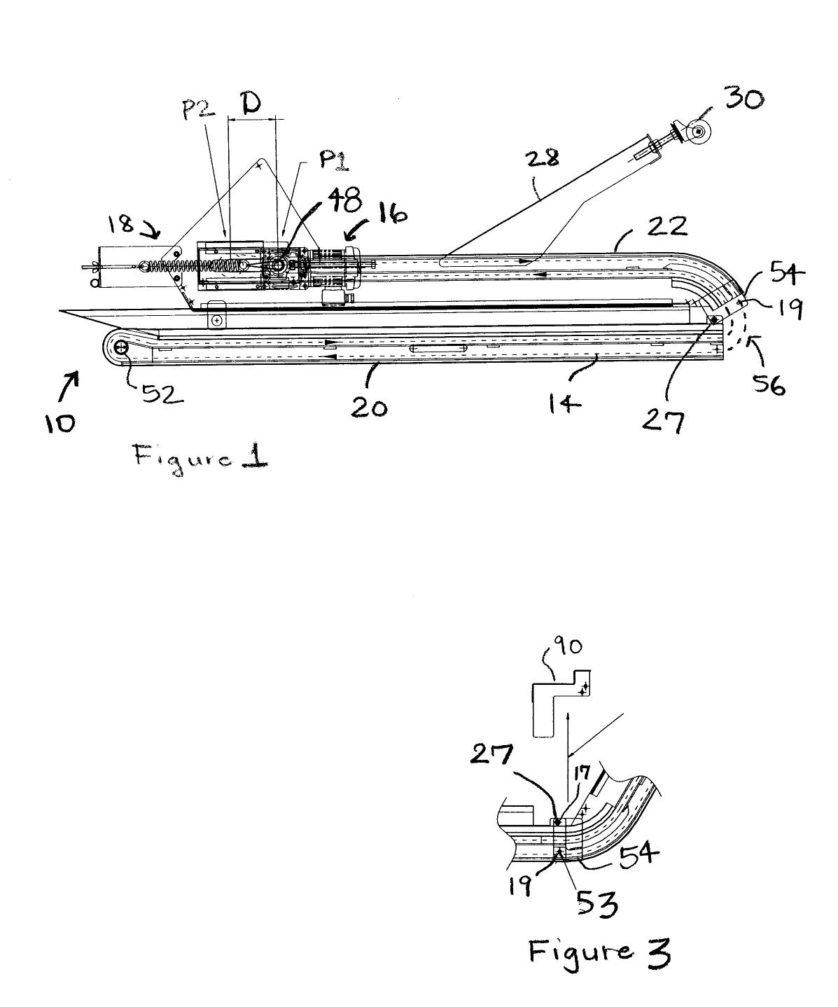

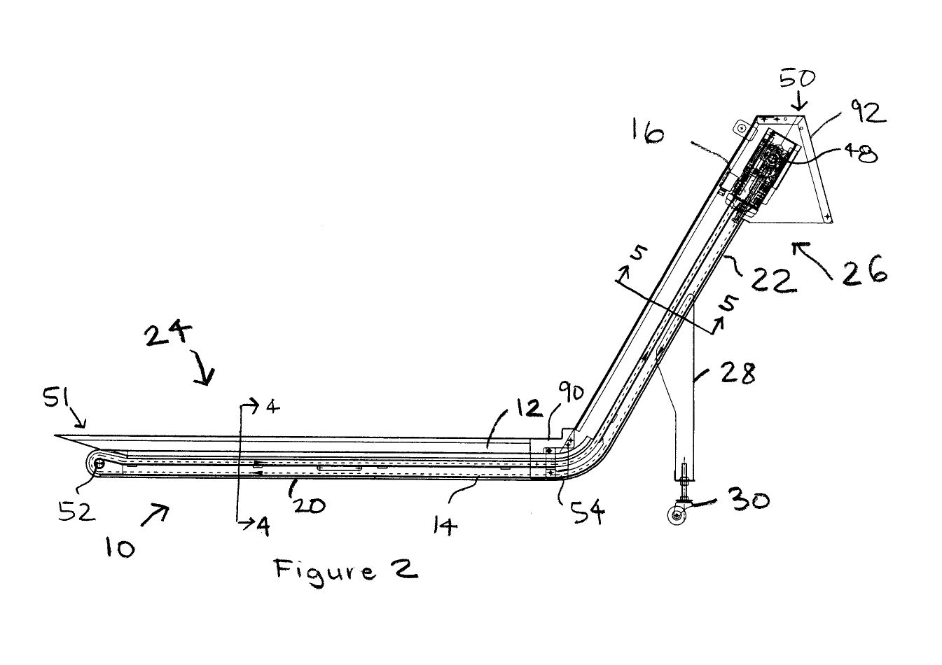

Referring now to the drawings, wherein like reference characters represent corresponding elements throughout the several views, and more specifically to FIGS. 1 and 2, the present invention will be described in the context of an exemplary foldable conveyor 10. The conveyor 10 is shown in FIG. 1 in a folded state and with an installed continuous belt 14 (indicated by dashed lines) and an automatic tensioning device 18. The conveyor 10 in the folded state can be supported on and bound to a pallet and placed inside a shipping container for shipping to a desired destination. FIG. 2 illustrates the conveyor 10 in an unfolded state in which the tensioning device 18 shown in FIG. 1 has been removed and in which the conveyor 10 is operable to convey material on the belt 14 from a loading area 24 to a discharge area 26.

Conveyor 10 generally includes a conveyor frame 12 for supporting the continuous belt 14 and a drive mechanism 16 for driving the continuous belt 14 during operation of the conveyor. The tensioning device 18 facilitates movement of a head shaft 48 and hence the end of the continuous belt 14 along a path having a distance D as the conveyor 10 is moved from the folded to the unfolded state, i.e., the head shaft 48 is moved from position P1 to position P2 with respect to the tensioning device 18 as the conveyor 10 is unfolded, as more fully described below, to prevent the belt 14 from interfering in the unfolding operation. Once the conveyor has been unfolded, the tensioning device 18 can be removed.

The belt 14 is preferably a hinged metal belt of known construction, but could also be a drag flight belt of known construction. The conveyor frame 12 includes two separate sections: a first horizontal loading section 20 and a second covered section 22 which is also referred to herein as an inclined section. In the unfolded state of the conveyor, inclined section 22 is preferably supported by a leg 28 and one or more casters 30, which facilitate movement of the conveyor 10.

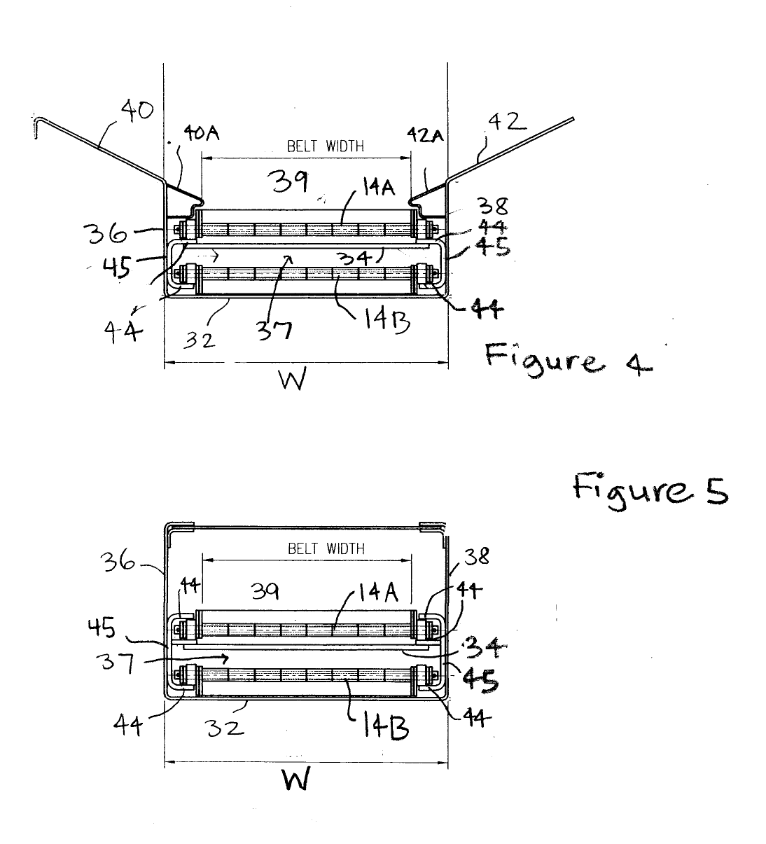

The two frame sections 20, 22 form a belt-guiding track which defines a course of movement for the belt 14 during operation of the conveyor. Specifically, with respect to FIG. 4, which is a cross sectional view through the loading section 20, loading section 20 includes a bottom horizontal wall 32, a central horizontal wall 34, and two lateral vertical walls 36, 38 with guidance extensions formed by walls 40, 42 extending outwardly therefrom and by walls 40A and 42A. The walls 32, 34, 36, 38 together define a lower channel 37 for belt portion 14B and an upper channel 39 above the lower channel 37 for belt portion 14A. During operation of the conveyor, the guidance extensions guide material onto the belt portion 14A in the upper channel 39 of the loading section 20. Low friction guiding surfaces 44 are provided on portions 45 to guide the belt portion 14A in the upper channel 39 and belt portion 14B in the lower channel 37. FIG. 5 illustrates a similar configuration for the inclined section 22, which further includes a cover wall 46 rather than the guidance extensions of the horizontal section 20. Both sections 20, 22 have substantially the same width, denoted by W.

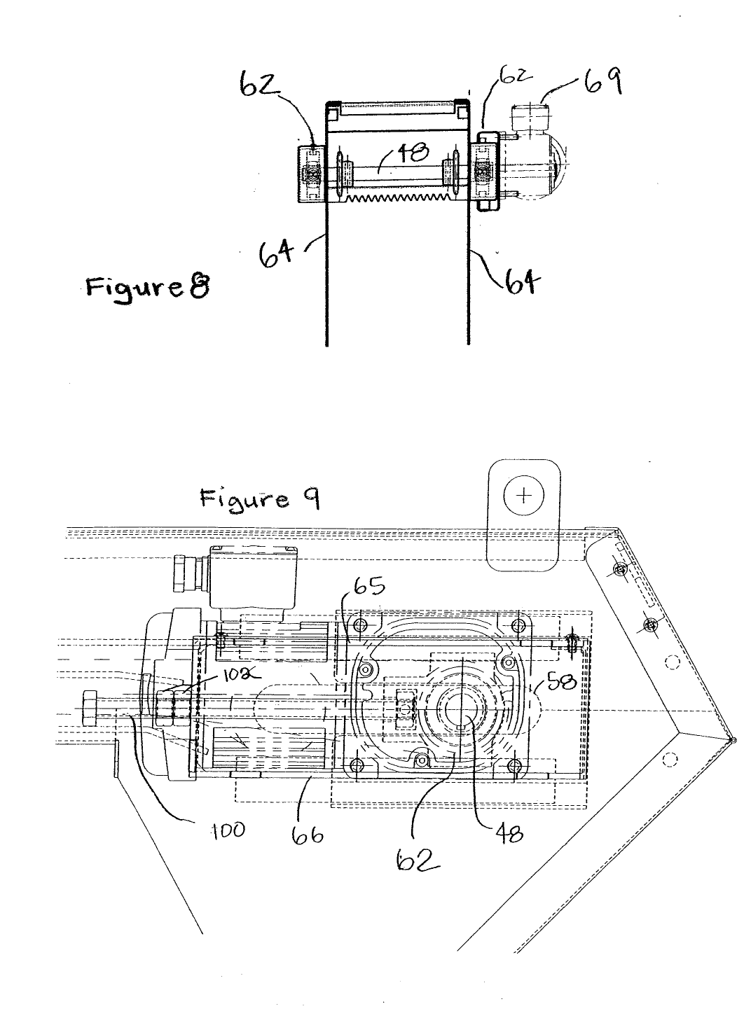

The belt 14 is mounted to move clockwise as viewed in FIG. 2 for conveying material from the loading area 24 to the discharge area 26 in a conventional manner, with the belt 14 passing from channel 39 to channel 37 around the head shaft 48 near a discharge end 50 of the conveyor 10 and passing back from channel 37 to channel 39 at a hub 52 near the other end 51 of the conveyor 10. Specifically, movement of the belt is caused by rotation of the head shaft 48, which is driven by the drive mechanism 16, which includes a motor 69 (see FIG. 8), in a known manner.

Referring again to FIG. 1, in the folded state, sections 20 and 22 are joined by pivot plates 54, one on each side of the conveyor 10. Each pivot plate 54 includes two holes 17, 19 along one edge and is attached along the opposite edge to section 22 preferably by welding. To allow folding, the pivot plate 54 is connected to the horizontal section 20 at a pivot axis 27 using a fastener such as a connecting rod (not specifically shown) through the upper hole 17. This simple pivot hinge allows the sections 20, 22 to be easily moved with respect to one another. Specifically, section 20 remains stationary and section 22 is pivoted around the pivot axis 27 to move the conveyor 10 between the folded and unfolded states and vice versa. In the folded state, section 22 is essentially horizontal and supported by the horizontal section 20, with a partial gap or open area formed between the two sections as indicated by 56.

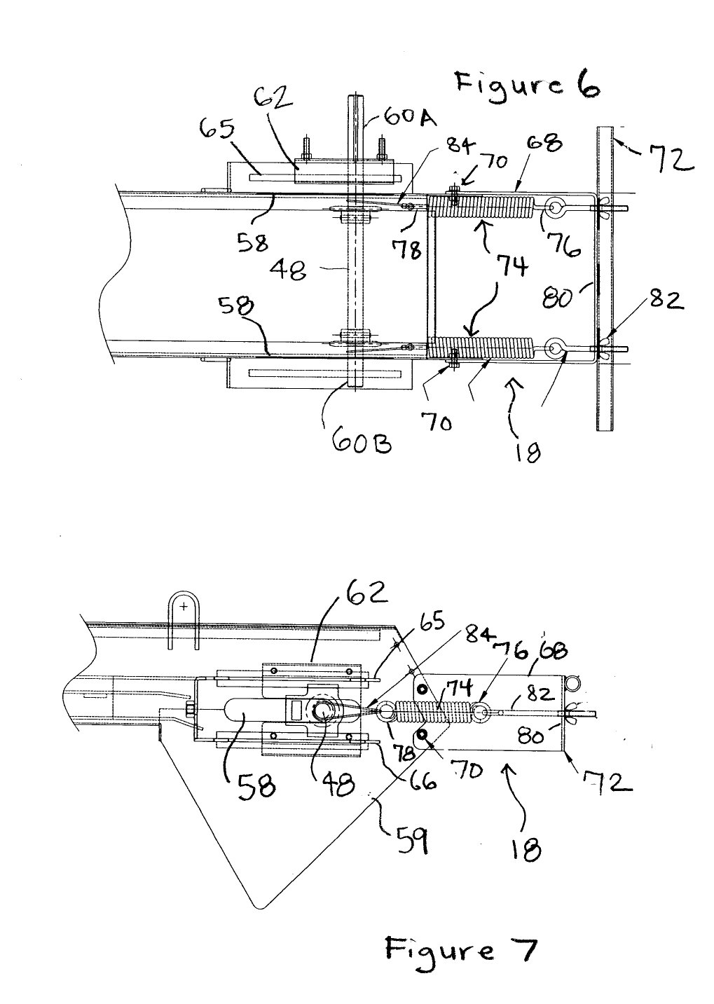

As best seen in FIGS. 6 and 7, a center slot 58 extending in a longitudinal direction is formed in each side wall 59 of the inclined section 22 of the conveyor frame. Ends 60A, 60B of the head shaft 48 extend through the slots 58 and are each supported in a respective bearing assembly 62 on the outer side 64 of a side wall 59. Each bearing assembly 62 includes slots which interface with complementary outwardly extending upper and lower guide bars or rails 65, 66, which are arranged above and below the center slot 58. A holding mechanism, such as a take-up bolt 100 with locking nuts 102 (see FIG. 9) is operable to hold the bearing assembly in a desired position, in which position the bearing assembly is prevented from moving back and forth with respect to the guide rails 65, 66, and the head shaft 48 is also prevented from moving back and forth in the center slot 58. When the bearing assembly 62 is not held in position, it is slidable with respect to the guide rails 65, 66, and the head shaft 48 is unconstrained as well and slidable in the center slot 58. When the head shaft 48 is unconstrained, its position in the slot 58 is affected by the tensioning device 18 and depends on whether the conveyor is in a folded or unfolded state.

In particular, the tensioning device 18 includes a three sided bracket 68 which is attached to the inclined section 22 with fasteners 70 such as screws, washers and nuts. An optional grip bar 72 for moving the sections 20, 22 with respect to each other can be attached to the bracket 68. A pair of extension springs 74 having first and second ends 76, 78 are connected between a center arm 80 of the bracket 68 and the head shaft 48. Specifically, each spring 74 is connected at the first end 76 to the center arm 80 using a fastener 82 such as an eyebolt and wing nut, and is connected at the second end 78 to a respective portion of the head shaft 48 using a fastener 84 such as a lanyard cable.

When the head shaft 48 is unconstrained, the tensioning device 18 operates to provide tension on the belt 14 (which is stationary during an unfolding operation) by providing a force to pull the head shaft 48 towards the grip bar 72. Fasteners 70, 82, and 84 are easily removable, such that the tensioning device 18 can be easily attached and removed from the conveyor frame 12.

Thus, the conveyor 10 is preferably shipped in its compact folded state with the belt 14 installed and the tensioning device 18 connected to the head shaft 48 which is unconstrained to slide in the center slots 58. With the conveyor 10 in the folded state, the springs 74 of the tensioning device 18 are extended from their configurations in an unfolded state. As the conveyor is unfolded, the tensioning device provides appropriate tension on the belt 14 to prevent it from interfering in the unfolding operation. In other words, as the conveyor 10 is unfolded, the tensioning device 18 draws the head shaft 48 closer to the discharge end 50 of the conveyor (i.e., closer to the grip bar) in order to take up any slack in the belt 14 and prevent it from extending outwardly or to the side in the area 56 and to allow the sections 20, 22 to come together, as shown in FIG. 2, without interference by the belt.

Thus, once the conveyor is unfolded, the tensioning device can be removed. First, as best seen in FIG. 3, the conveyor frame sections 20 and 22 can be secured to one another, such as by using inserting a fastener 53 (one on each side) through hole 19 to secure the lower portion of the pivot plate 54 to section 20. Next, the holding mechanism is used to hold the bearing assembly in place such that the head shaft 48 is constrained in position and the fasteners 82, 84 and 70 can be removed to remove the springs 74 and bracket 68.

Various other components of the conveyor 10 can then also be added. For example, a lower curve housing piece 90 as shown in FIGS. 2 and 3 is preferably also attached which can function as a baffle on the lower curve of the conveyor 10. A discharge cover plate 92 is preferably added to the discharge end 50 of the conveyor 10. Safety slot covers can also provided to cover the slots for the head shaft. These components are typically shipped unassembled but are easy to add to obtain the operable conveyor 10 shown in FIG. 2. The leg 29 and caster 30 can be attached either prior to or after shipping, and adjusted to a desired height.

It should be understood that the preferred embodiment of the conveyor 10 with tensioning device 18 as described above is only exemplary and does not limit the scope of the invention, and that various modifications could be made by those skilled in the art that would fall under the scope of the invention. For example, the tensioning device 18 is shown using mechanical extension springs, while in other embodiments, other types of springs, such as a gas or pneumatic spring, could also be used to provide appropriate tension on the belt 14 and prevent interference during the unfolding operation.

To apprise the public of the scope of this invention, we make the following claims:

We claim:

1. A foldable conveyor comprising:
a conveyor frame having a first section that is pivotable with respect to a second section such that the conveyor frame is movable between a folded state and an unfolded state,
a continuous belt disposed on the conveyor frame, and
a tensioning device for providing tension on the belt when the conveyor frame is moved from the folded state to the unfolded state to prevent the belt from interfering with the unfolding operation.

2. The foldable conveyor of claim 1, wherein the tensioning device is removable.

3. The foldable conveyor of claim 1, wherein an open area is formed between the sections when the conveyor frame is in a folded state, and the open area is closed when the conveyor frame is in an unfolded state and the tensioning device prevents the belt from extending into the open area during an unfolding operation.

4. The foldable conveyor of claim 1, wherein the tensioning device includes one or more springs.

5. The foldable conveyor of claim 4, wherein the tensioning device includes a mechanical extension spring.

6. The foldable conveyor of claim 4, wherein the tensioning device includes a pneumatic spring.

7. A foldable conveyor comprising:
a conveyor frame including a loading section and an inclined section having side walls with slots formed therein, and with a pivot hinge between the loading section and the inclined section such that the conveyor frame is foldable,
a head shaft which is slidable in the slots formed in the side walls,
a continuous belt guided by the conveyor frame and disposed around the head shaft and a hub, and
a removable tensioning device including a spring bracket mounted to one end of the inclined section, the spring bracket being connected to one end of at least one extension spring, wherein the other end of the extension spring is connected to urge the head shaft toward the spring bracket, and wherein the head shaft moves within the slots with respect to the spring bracket as the conveyor frame is moved between a folded state and an unfolded state.

8. The foldable conveyor of claim 7, wherein the spring is stretched more when the conveyor frame is in the folded state than the unfolded state.

9. The foldable conveyor of claim 7, wherein the tensioning device provides tension on the belt when the conveyor frame is moved from the folded state to the unfolded state and prevents the belt from bunching in an open area formed between the two sections in the folded state.
